(19) United States
(12) Patent Application Publication
(10) Pub. No.: US 2002/0088474 A1
(43) Pub. Date: Jul. 11, 2002

(54) Coolbrush oral hygiene system

(76) Inventor: Michael D. Montalvo, Washington, DC (US)

Correspondence Address: Michael J. Foycik, Jr., 1718 M St. N.W., #255, Washington, DC, 20036, US

(21) Appl. No.: 09/746,461

(22) Filed: Dec. 26, 2000

(51) Int. Cl. A45D 44/18; A61D 5/00

(52) U.S. Cl. 132/309; 222/181.3

(57) ABSTRACT

An oral cleansing system includes a toothbrush, dental floss, dental floss dispenser, and an oral cleansing solution. The system provides a liquid oral cleanser that converts to a thick cleansing foam when it undergoes a phase change by a physical agitator. Further, the system provides a formulation to aid in maintaining the oral cavity clean after the initial brushing. Specifically, the oral solution introduces a second stage of oral cleansing by applied lipido-lysogenic lipases which will control the reproduction of oral micro-bacteria well after the initial cleansing by brushing. This is used in a device for dispensing and storing the oral cleanser within a unit that is integrated with a toothbrush, thus creating a portable oral hygiene system that is very convenient and useful for a person at work, away from home, or travelling. The system includes a floss dispenser within a cylindrical sheath that is divided into two compartments. One of the compartments is allocated for holding a spool of floss. The other compartment is used as a toothbrush cover. The floss compartment has a cover that has a shaft upon which the spool is placed. The cover has a dispensing hole and a floss cutter distal to each other. In between the hole and the cutter, a section has been concaved circular to facilitate the grasping of the floss; when it is extended across and pinched at the floss cutter after being cut. This method is designed to leave a significant and sufficient length of floss for grasping for future use. The system includes a novel liquid oral cleansing solution having potassium(chloro)fluoride and benzoic acids, causing immediate cleansing of bacteria.

### FIELD OF THE INVENTION

The present invention relates to an oral cleansing system, which is an oral hygiene system, having a toothbrush and oral cleansing solution. More particularly, the invention relates to an oral cleansing system having a toothbrush, dental floss, dental floss dispenser, and an oral cleansing solution.

### BACKGROUND OF THE INVENTION

Many types of devices are known for use in oral hygiene. For example, toothbrushes are well known. And, portable assemblies having a toothbrush and toothpaste are also known.

There are a number of patented devices which encompass the concept of specialized toothbrushes that dispense conventional toothpaste and other dental care products built in one unit. These devices address the problem in the art of how to store and dispense a toothpaste from within the unit. Most such devices employ a screw-driven plunger internally disposed in a casing for storing the toothpaste, which would also be used as a handle. In such devices, a dial of some type is often used to turn the screw driven plunger to dispense a desired amount of toothpaste, which can take several turns to accomplish this. This requires a significant effort to perform the toothpaste-dispensing function intended of these prior devices.

For example, in U.S. Pat. No. 6,009,886 issued Jan. 4, 2000 to Labranche et al., a combination dentifrice and floss dispensing toothbrush are shown. This patent demonstrates dispensing of dental floss, a first compartment, and a sheath associated with a second compartment for receiving a spool of floss or passage of a thread of floss. A floss cutoff device is provided which can be a simple metal blade which is attached adjacent to a pinhole which enables passage of the dental floss. However, it is a disadvantage that such positioning of the floss dispensing hole and cutter are proximal, since in that case no floss string of any appreciable length would be left after the initial cut. This is a disadvantage because very little floss, if any, would remain exposed for future usage, which makes grasping of the dental floss for dispensing difficult.

U.S. Pat. No. 5,865,195 to Carter teaches an oral hygiene system. The system includes a sealed storage/rinsing tube and a hygiene assembly sealed within the tube.

U.S. Pat. No. 4,957,125 to Yaneza teaches a toothbrushing assembly. This assembly includes dispensers for both toothpaste and for dental floss.

U.S. Pat. No. 5,832,940 to Embry et al. teaches a self-contained toothbrush construction. In this device, a handle contains dentifrice and carries a toothbrush head. The handle portion is insertable into a telescoping cover portion.

U.S. Pat. No. 4,269,207 to Konrad et al. teaches a combined toothbrush-toothpaste container. The container includes a housing and rigid piston to express toothpaste from the container into a toothbrush head.

U.S. Pat. No. 5,842,487 to Ledet teaches a self-contained toothbrush. The toothbrush includes a toothpaste container portion receiving a toothpaste cartridge.

U.S. Pat. No. 5,950,641 to Taveras teaches a dental floss and toothpick dispensing compartment for toothbrushes. The handle portion contains two chambers, one for toothpicks and one for dental floss.

The patented devices discussed above are designed around conventional toothpastes or gels that already exist on the market. These prior art devices generally use an internal plunger of some type with a mechanism that pushes it within the chamber of the unit that contains the toothpaste, which forces the toothpaste to be dispensed. Further, the problem of dehydration of the toothpaste within the neck of the unit has been addressed by adding a shutter device or closure unit of some type. However, conventional toothpastes or gels were not intended or formulated to be dispensed in such a way. Thus, it is a problem in the art to provide a device and formulation adapted specifically to overcome this problem.

As seen from the prior art, one of the other problems commonly faced is the dehydration of the dental paste within the neck and head passage of the unit, by being exposed to air through the outlet(s) of the toothbrush. In turn this causes the paste or gel to harden and cause possible blockage or waste and interfere with the functionality of the unit. In the prior art the problem has been frequently been resolved by placing a shutter or a valve of some type at the outlet of the toothbrush head.

No valve or shutter of any kind is needed to prevent dehydration of any paste or gel as seen in prior art, because this invented system includes the use of “unique” liquid oral cleansing solution that is changed to a foamed solution. What is left in the head and neck passage will reduce to form a liquid residue of minute proportions, and will not prevent subsequent dispensing. The minute residue will reconstitute with the foam with each new discharge. The integrity of the head and neck passage will be cleared and maintained through continued usage. As a result of not having to use an exit valve or shutter makes the manufacturing of few components cost effective and simplifies assembly.

Additionally, oral cleansers such as dental paste, gel, powders and oral rinsers like “mouth wash” are used to cleanse the oral cavity. Toothpastes, gels and powders are used in combination with a toothbrush to cleanse by the method of brushing and the combination of ingredients found in said dental cleansers that kill bacteria upon contact. This method cleanses most of the oral surfaces. Oral rinsers “mouth wash” are used to kill bacteria that brushing alone do not reach. These conventional oral cleansers achieve the cleansing intended, but the effectiveness is short lived. Bacterial reproduction accrue in one or two hours later, or even minutes later. Making the cleansing of the oral cavity through conventional methods ineffective.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an oral cleansing system having a toothbrush and oral cleansing solution. More particularly, the invention relates to an oral cleansing system having a toothbrush, dental floss, dental floss dispenser, and an oral cleansing solution.

The present invention addresses the above-discussed problems in the prior art. Specifically, the present invention provides a liquid oral cleanser that converts to a thick cleansing foam when it undergoes a phase change by a physical agitator.

Further, the present invention provides a formulation to aid in maintaining the oral cavity clean after the initial brushing. Specifically, the oral solution introduces a second stage of oral cleansing by applied lipido-lysogenic lipases which will control the reproduction of oral micro-bacteria well after the initial cleansing by brushing.

The present invention accordingly provides an advantageous oral solution for the type of system that prior inventions have tried to use with conventional toothpaste. This is used in a device for dispensing and storing the oral cleanser within a unit that is integrated with a toothbrush, thus creating a portable oral hygiene system that is very convenient and useful for a person at work, away from home, or travelling.

The present invention also includes a floss dispenser. This addresses and resolves the problems seen in the prior art by improving the method and design of dispensing dental floss. The inventive design places the floss dispenser within a cylindrical sheath that is divided into two compartments. One of the compartments is allocated for holding a spool of floss. The other compartment is used as a toothbrush cover. The floss compartment has a cover that has a shaft upon which the spool is placed. The cover has a dispensing hole and a floss cutter distal to each other. In between the hole and the cutter, a section has been concaved circular to facilitate the grasping of the floss; when it is extended across and pinched at the floss cutter after being cut. This method is designed to leave a significant and sufficient length of floss for grasping for future use. As a result of this method, the functionality of the floss dispenser in a sheath use as toothbrush cover has been made effective, simple and less complicated.

The oral cleansing system of the present invention has addressed and resolved this problems in the prior art by using a unique liquid oral cleansing solution. By flossing and then brushing with this liquid solution (in a conventional method) the solution behaves much like normal toothpaste, gel or powders through the disruption of bacteria by action of the bristle in combination with potassium(chloro)flouride and benzoic acids, causing immediate cleansing of bacteria. But it has a second stage of controlling the reproduction of degenerative microorganisms well after the initial cleansing through brushing. This is accomplished by coating the oral cavity with million of “bait-like” structures called lipido-lysogenases. These unique structures are very attractive to the oral micro-organisms and are ingested by the micro bacteria. Upon ingestion, the microorganisms will lyse or rupture, thus controlling the reproduction of oral bacteria. Since these unique “bait like” structures bond to the oral cavity surfaces, the rinsing performed after the initial brushing will not wash them away, leaving millions of such structures in the mouth to continue to kill off bacteria, keeping the oral cavity cleansed for a significantly longer period of time. This, in combination with a special delivering device/toothbrush/dental floss dispenser, forms a very effective oral cleansing system.

Other objects and advantages of the present invention will be more readily apparent from the following detailed description when read in conjunction with the accompanying drawings.

### BRIEF DESCRIPTION OF THE DRAWINGS

FIG. 1 is a side sectional view of an oral cleansing system according to the present invention.

FIG. 2A is a front elevational view of a canister nozzle used in the system of FIG. 1.

FIG. 2B is a side elevational view of the canister nozzle of FIG. 2A.

FIG. 2C is a top elevational view of the canister nozzle of FIG. 2B.

FIG. 3 is an axial view of chambers of the assembly of FIG. 1.

FIG. 4A is an elevational view of the top of an actuator button, seen from the left side of the device of FIG. 1.

FIG. 4B is a side elevational view of the actuator button of FIG. 4A.

FIG. 5A is an elevational side view of a receiving portion of a plastic button housing, as used in the device of FIG. 1.

FIG. 5B is a top elevational view of the receiving portion of the button housing of FIG. 5A.

FIG. 6 is an assembly view showing the insertion of the actuator button of FIG. 4A into the receiving portion of the plastic button housing of FIG. 5A.

FIG. 7A is a top elevational view of a floss dispenser, as seen from the left side of the device of FIG. 1.

FIG. 7B is a side elevational view of the floss dispenser of FIG. 7A.

FIG. 7C is a bottom elevational view of the floss dispenser of FIG. 7A.

FIG. 8 is an elevational view of a dental floss cutter usable in the present invention.

FIG. 9A is a top elevational view of an alternative embodiment of a floss dispenser, similar to that shown in FIG. 7A.

FIG. 9B is a side elevational view of the alternative embodiment floss dispenser shown in FIG. 9A.

FIG. 10A is a top elevational view of a wall mountable dispenser according to the present invention.

FIG. 10B is a front elevational view of the wall mountable dispenser of FIG. 10A.

FIG. 10C is a side elevational view of the wall mountable dispenser of FIG. 10B.

FIG. 11A is a top elevational view of a dispenser/canister cover according to the present invention.

FIG. 11B is a front elevational view of the dispenser/canister cover of FIG. 11A.

FIG. 12 is a top elevational assembly view of a toothbrush having a dispensing head, according to the present invention.

FIG. 13 is a side sectional view of the toothbrush of FIG. 12.

FIG. 14 is an elevational view of a circular seal used in the toothbrush of FIG. 12.

FIG. 15 is a side schematic elevational view of the toothbrush of FIG. 12 assembled with the wall mountable dispenser of FIG. 10A.

FIG. 16 is a schematic view of the operation of dispensing two fluids through an agitator, according to the present invention.

### DETAILED DESCRIPTION OF THE INVENTION

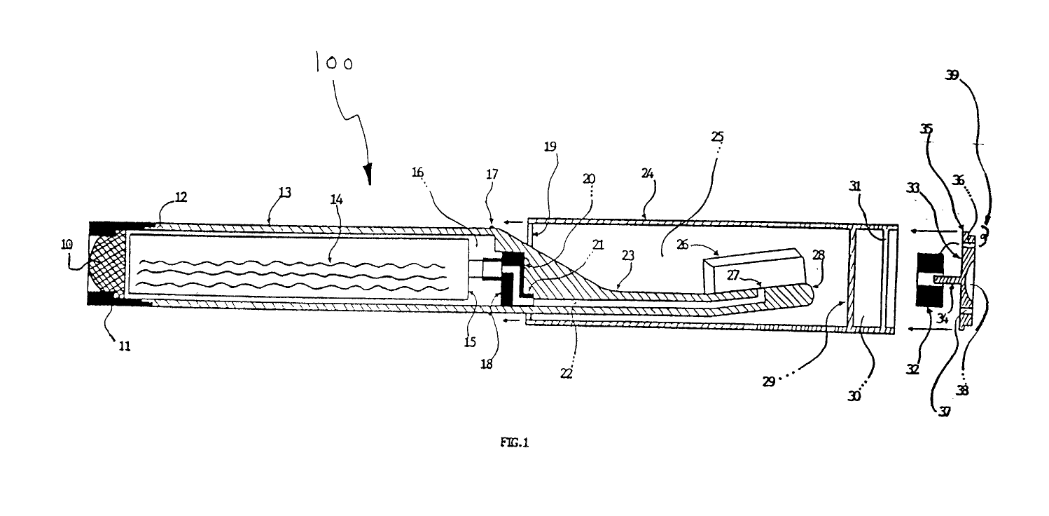

FIG. 1 is a side sectional view of an oral cleansing system 100, having a plastic button 10, a plastic cylindrical housing 13 receiving the button 10, a plastic cylindrical sheath 24 having two compartments and joining with the housing 13, and a dental floss dispenser/compartment cover 33 having a locking lip ring 35 closing an end of the plastic cylindrical sheath 24.

The plastic button 10 is received inside a plastic button housing 11 having two open ends. One open end of the plastic button housing 11 mates with the housing 13 at a rabbet or interlocking joint 12, and the other open end of the plastic button housing 11 receives the plastic button 10. While the button 10 is described as being plastic, it is not limited thereto and may be constructed of other materials as well, such as rubber, metal, ceramics, or wood.

The housing 13 has a raised ridge 17 which is provided to serve as a “lock-ring” when joined with the sheath 24. The housing 13 contains a unique oral cleansing solution 14 in accordance with the present invention, which is described further hereunder. The unique oral cleansing solution 14 is contained within a plastic or metal discharging canister 15 having a nozzle. The housing 13 has an interior portion forming a canister chamber 16, for receiving the discharging canister 15.

The housing 13 serves as a handle portion for an integrally attached toothbrush neck 23. The toothbrush neck 23 carries a toothbrush head 28 which is preferably composed of plastic. The toothbrush head 28 is integrally attached to neck 23, and has bristles 26 which can have differing shapes or arrangements which would be known to any one having skill in the toothbrush art. The bristles 26 can be arranged also in accordance with placement of an outlet 27 which conveys fluid from the discharging canister 15 to the toothbrush head 28. While a single outlet 27 is shown, it is contemplated as being with the scope of the present invention that a plurality of outlets 27 may be provided, and all such variations are encompassed by the present invention.

The nozzle of the discharging canister 15 is connected to a canister-nozzle-to-channel disc 18, which may be composed of plastic or metal, for example. While the disc 18 is described as being plastic or metal, it is not limited thereto and may be constructed of other materials as well, such as rubber, ceramics, or wood, among others.

The disc 18 has a through passage having two ends, the first end of which is connected to receive discharged fluid or foam from the canister 15. The second end of the disc 18 discharges the received fluid or foam into a passage or conduit 22 which leads to the bristled surface outlet 27.

The plastic cylindrical sheath 24 has an interior compartment 25, serving as a toothbrush neck and head compartment, for receiving the toothbrush portion 28. The plastic cylindrical sheath 24 also includes a compartment separation wall 29, a dental floss compartment 30, a ring-like groove or channel 31 and the inner wall of the floss compartment 30 used to form a joint so as to “lock” a floss dispenser/compartment cover 33.

Furthermore, the sheath 24 includes a channel-like groove or recess 19 which mates with the raised ridge 17 of the housing 13, to releasably secure the sheath to the housing 13. The disk 18 rests against a wall 20 formed in the toothbrush neck 23, and is received in a chamber 21 in the neck 23.

The compartment 30 receives a dental floss spool 32. The spool 32 is carried by a dental floss dispenser/compartment cover spool shaft 34 formed on the floss dispenser/compartment cover 33. The cover 33 also includes a dental floss dispensing aperture 36 which permits passage therethrough of a strand 39 of the dental floss 32 and a dental floss cutter slot 37. The cutter slot 37 is preferably formed of metal or plastic. The cover 33 includes a concave portion 38.

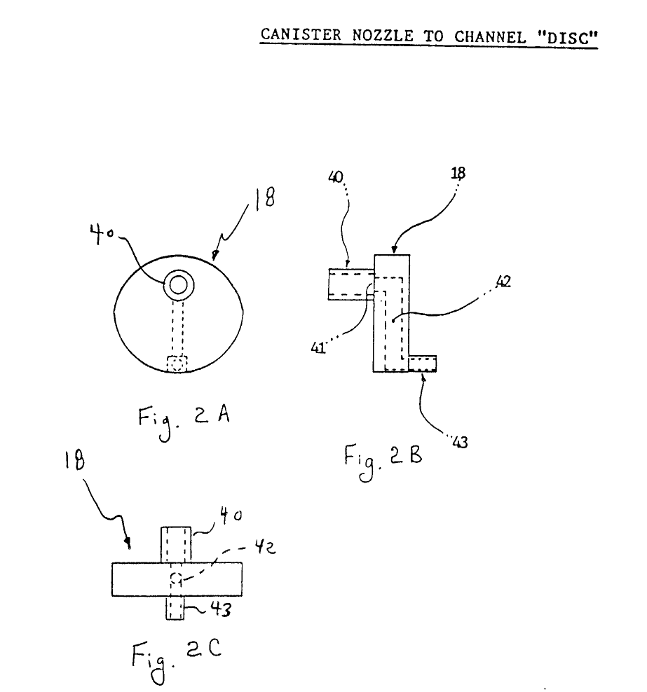

FIG. 2A is a front elevational view of the canister nozzle disc 18 used in the system 100 of FIG. 1. As seen in this view, the disc 18 has a nozzle portion 40 for connecting the canister nozzle disc 18 with the passage 22. FIG. 2B is a side elevational view of the canister nozzle disc 18 of FIG. 2A, showing a nozzle 43 opposite to the nozzle 40, and also showing in dashed outline a transverse connecting passage 42 which connects the nozzle 43 to the nozzle 40. FIG. 2C is a top elevational view of the canister nozzle disc 18 of FIG. 2B, showing the nozzles 40 and 43. FIG. 2C also shows a nozzle restricting area 41.

FIG. 3 is an axial view of the housing 13 showing the chambers therein. Specifically, FIG. 3 shows an irregular shaped chamber 44 for receiving the disc 18, guide points 45a and 45b serving as irregular shaped chamber disc guide points, and an offset arc 46 within the circumference of the canister chamber 16. Also shown is the conduit 22 and the chamber 21 which have been described hereinabove.

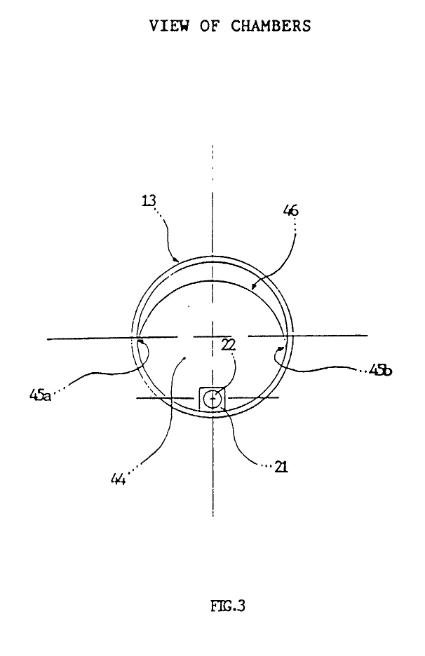

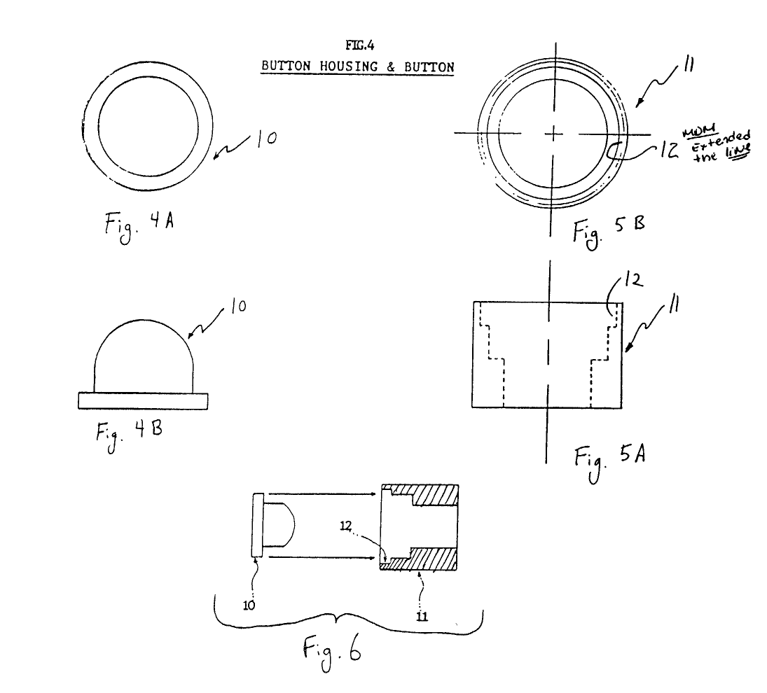

FIG. 4A is an elevational view of the top of the actuator button 10, seen from the left side of the device of FIG. 1. FIG. 4B is a side elevational view of the actuator button 10 of FIG. 4A.

FIG. 5A is an elevational side view of a receiving portion 12 of a plastic button housing 11, for receiving the actuator button 10 of FIG. 4A, as also shown in the FIG. 1. FIG. 5B is a top elevational view of the receiving portion 12 of the button housing 11 of FIG. 5A.

FIG. 6 is an assembly view showing the insertion of the actuator button 10 of FIG. 4A into the receiving portion 12 of the plastic button housing 11 of FIG. 5A.

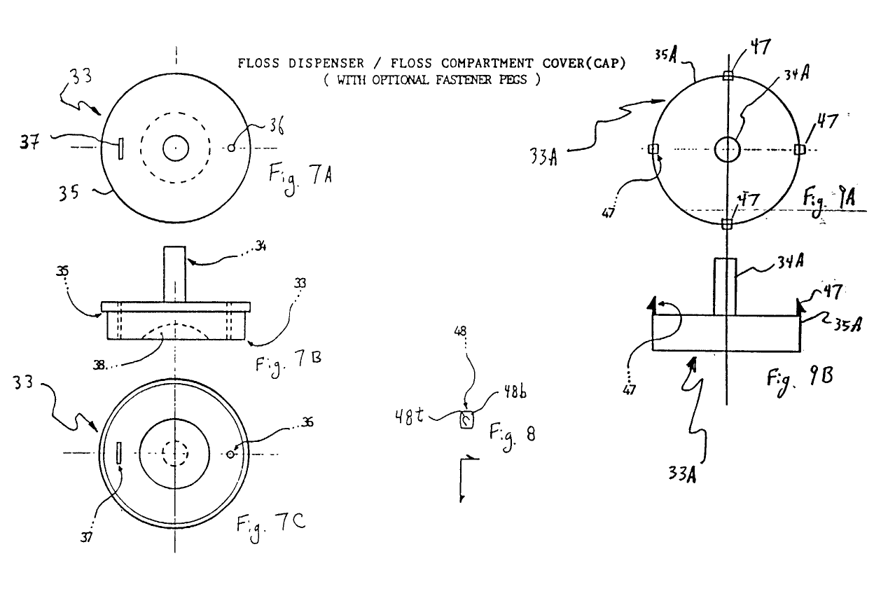

FIG. 7A is a top elevational view of a dental floss dispenser/compartment cover 33 as seen from the left side of the device 100 of FIG. 1. As seen in FIG. 7A, the dental floss dispenser/compartment cover 33 has a locking lip ring 35, a dental floss dispensing hole 36, and a dental floss cutter slot 37. The dental floss dispenser/compartment cover spool shaft 34 is shown clearly in this view. FIG. 7B is a side elevational view of the floss dispenser 33 of FIG. 7A, showing the concave portion 38 in dashed outline. FIG. 7C is a bottom elevational view of the floss dispenser 33 of FIG. 7A.

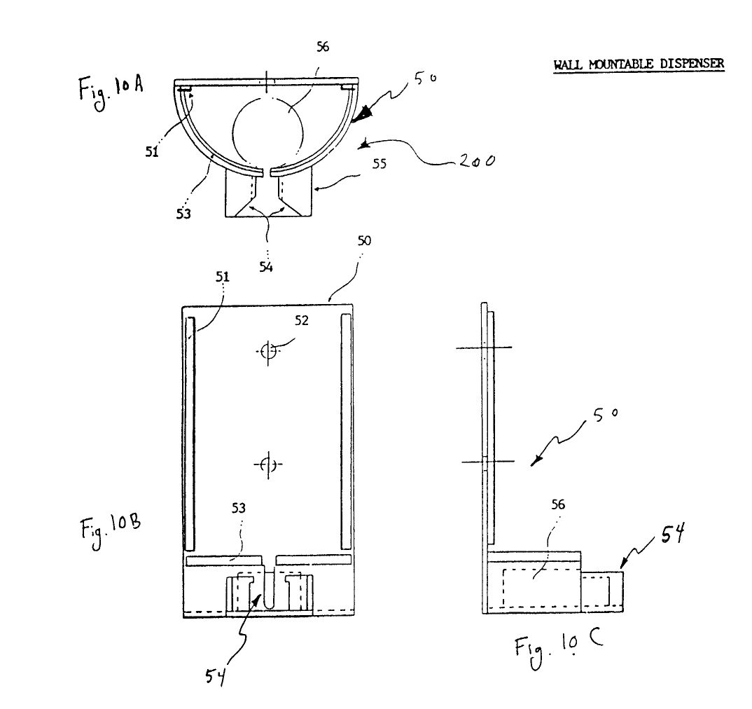

FIG. 8 is an elevational view of a dental floss cutter 48 usable in the present invention. The cutter 48 has a base portion 48b and a tab portion 48t.

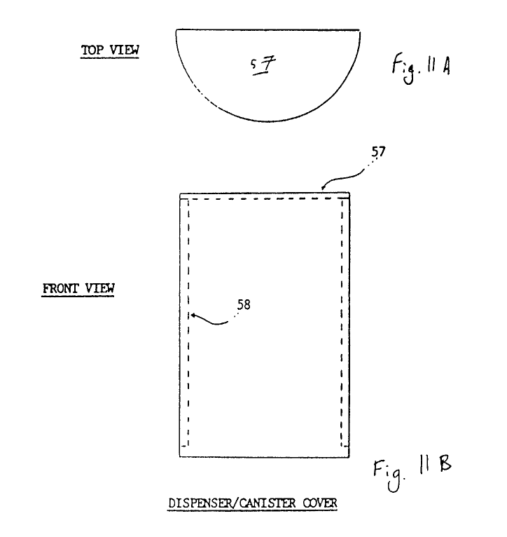

FIG. 9A is a top elevational view of an alternative embodiment of a floss dispenser 33A, similar to that shown in FIG. 7A for the dispenser 33. In this view, a plurality of fastener pegs 47 are provided (four are shown) which are attached to the optional to the locking lip ring 35A. FIG. 9B is a side elevational view of the alternative embodiment floss dispenser 33A shown in FIG. 9A. Other fastening means can be used instead of the pegs 47, as would be known by one skilled in the fastening arts, and all such variations are contemplated as being within the scope of the present invention.

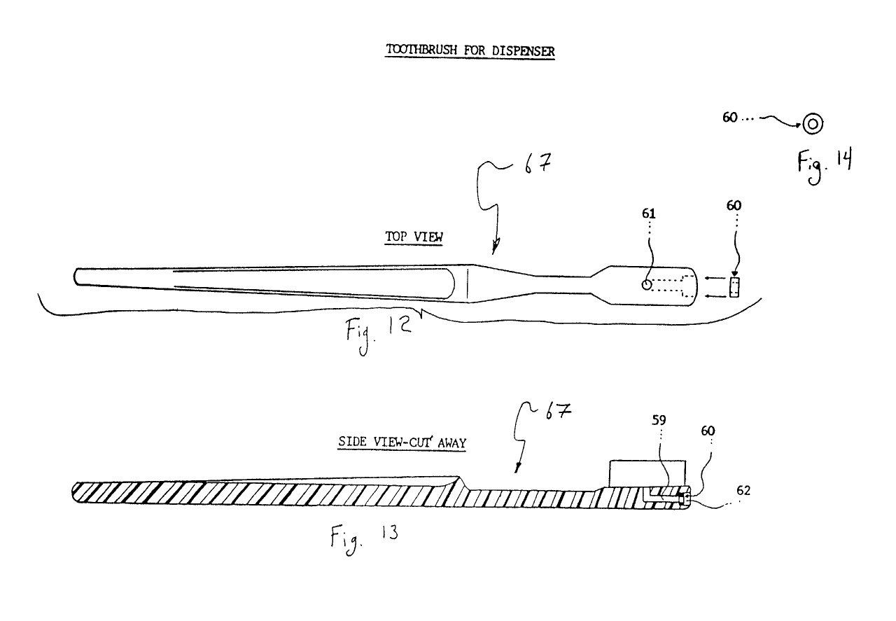

FIG. 10A is a top elevational view of an alternative embodiment of the oral cleansing system 200. FIG. 10B is a front elevational view of the wall mountable dispenser 50 of FIG. 10A, and FIG. 10C is a side elevational view of the wall mountable dispenser 50 of FIG. 10B. A wall mountable dispenser 50 is shown in this view which includes a flange section 51 formed as guide rails 51, used for sliding a dispenser/canister cover 57 in place on the dispenser 50. The guide rails 51 are generally L-shaped. A pair of screw holes 52 are shown in the dispenser 50 (shown in FIG. 10B). A rabbet joint 53 (rib and groove type of joint) is provided for attaching the dispenser/canister cover 57 onto the dispenser base. A wide angle opening 54 is provided to ease the inserting of the toothbrush head into the dispensing section of the dispenser 50. This is also used to guide the toothbrush head into a more precise narrowing path to align the toothbrush head cylindrical conduit 59 (shown in FIGS. 12 and 13) to the canister nozzle. An extension 55 of the dispenser base is provided, which is designed to simplify the mating of the toothbrush head conduit to the canisters' nozzle. It has a wide angle opening narrowing to a more precise shaped section with two lips that go over the outer section of the bristled surface of the toothbrush head. As shown in FIG. 10C, a section 56 of the dispenser is provided where the nozzle head of the canister containing the liquid oral solution is fitted into the base.

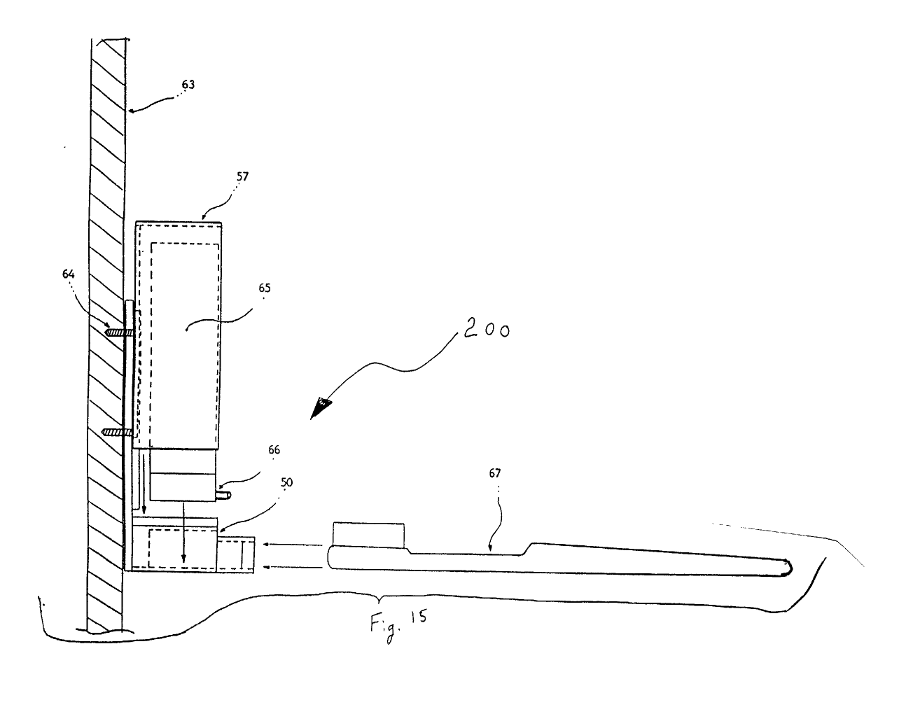

FIG. 11A is a top elevational view of the dispenser/canister cover 57. FIG. 11B is a front elevational view of the dispenser/canister cover 57 shown in FIG. 11A. This view shows a portion 58 which covers the flanged section that slides into the flanged section of the dispenser base.

FIG. 12 is a top elevational assembly view of an alternative embodiment of a toothbrush 67, usable in the device of FIGS. 10A, 10B, 10C, 11A, and 11B. In this view, a bristled surface outlet 61 is shown. While such outlet 61 is shown, the present invention is not limited to only one, and a plurality of outlets can be provided as well. Also shown is a circular seal 60, which is a washer like element, and is used to create a seal when the conduit mates with the nozzle. The seal 60 is also used as a buffer between the two.

FIG. 13 is a side sectional view of the toothbrush 67 of FIG. 12. In this view, a cylindrical conduit 59 is shown connecting the aperture 61 to the seal 60. The seal 60 is shown in section in this view. A section 62 is provided within the cylindrical conduit 59 which is allocated for the circular seal 60.

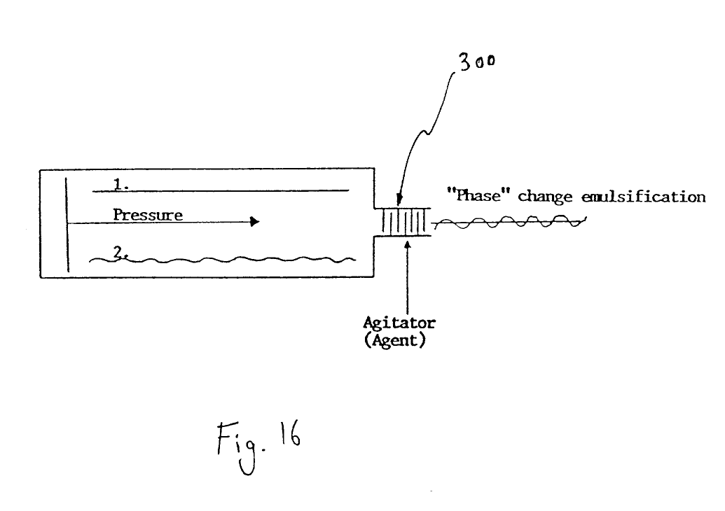

FIG. 14 is an elevational view of the circular seal 60 used in the toothbrush shown in FIG. 12.

FIG. 15 is a side schematic elevational view of the oral cleansing system 200 including the toothbrush 67 of FIG. 12 assembled with the wall mountable dispenser 50 of FIG. 10A. The view is an assembly view, showing the toothbrush 67 being inserted into the wall mountable dispenser 50. In this view, screws 64 have been screwed into the wall, to mount the dispenser 50.

FIG. 16 is a schematic view of the operation of dispensing two fluids 1 and 2 from a canister 15 through an agitator 300. The agitator may be a mechanical elements, such as a series of baffles or other complex arrangement serving to agitate fluid as it flows therethrough. The agitator 300 can even include a turbine-like portion, actuated by flow fluid, or it can be externally powered. Further, the agitator 300 may be a chemical agent such as a catalyst, catalyzing a reaction between the fluids 1 and 2.

In operation, the cylindrical housing 13 which is part of the oral cleansing system 100 is used as a handle. The housing 13 will contain not the toothpaste itself, but rather houses a separate canister containing a unique liquid oral cleansing solution 14 with a specific discharge. The present invention reduces the effort of use by simplifying its dispensing method. It is done simply by the push and hold of the button 10, then releasing the button 10 when the desired amount of oral cleanser 14 is acquired. So then, a screw driven plunger as seen in prior art is not used. When the button at the rear-end of the unit is pushed against the bottom end of the canister 15, it causes the canister 15 to move forward which then puts pressure against the nozzle portion thereof that releases the liquid oral cleanser, and in turn the liquid solution 14 is forced through the agitating agent 300 (shown in FIG. 16), converting the liquid 14 into a thick foam solution. What forces the liquid/foam through the neck and head conduit and out the exit(s) of the unit, is contained in the canister itself, as described hereinabove. Thus, it is quick and simple to use.

One of the other problems solved by the present invention addresses the issue in the prior art of dehydration of the dental paste within the neck and head passage of a unit, by being exposed to air through the outlet(s) of the toothbrush. In turn it will cause the paste or gel to harden and cause possible blockage or waste and interfere with the functionality of the unit. In prior art the problem has been resolved by placing a shutter or a valve of some type at the outlet of the toothbrush head.

However, according to the present invention, no valve or shutter of any kind is needed to prevent dehydration of any paste or gel such as is seen in prior art, because the present invention uses the unique liquid oral cleansing solution 14 that is changed to a foamed solution. What is left in the head and neck passage will reduce to form a liquid residue of minute proportions, and will not prevent subsequent dispensing. The minute residue will reconstitute with the foam with each new discharge. The integrity of the head and neck passage will be cleared and maintained through continued usage. As a result of not having to use an exit valve or shutter (as in the prior art) thereby necessitates fewer components, rendering the manufacturing of those fewer components cost effective and thus also simplifies assembly.

The oral cleansing system 100 includes a floss dispenser 33 as described hereinabove. The design thereof places the floss dispenser 33 within the cylindrical sheath 24 that is divided into two compartments. One of the compartments is allocated for holding a spool of floss 32. The other compartment is used as a toothbrush cover. As discussed above, the floss compartment has a cover that has a shaft upon which the spool is placed. The cover has a dispensing hole and a floss cutter distal to each other. In between the hole and the cutter, a section has been concaved circular to facilitate the grasping of the floss; then it is extended across and pinched at the floss cutter after being cut. This method is designed to leave a significant and sufficient length of floss for grasping for future use. As a result of this method, the functionality of the floss dispenser in a sheath used as toothbrush cover has been made effective, simple and less complicated.

Oral cleansers such as dental paste, gel, powders and oral rinsers like “mouth wash” are used to cleanse the oral cavity. Toothpastes, gels and powders are used in combination with a toothbrush to cleanse by the method of brushing and the combination of ingredients found in said dental cleansers that kill bacteria upon contact. This method cleanses most of the oral surfaces. Oral rinsers such as “mouth wash” are used to kill bacteria that brushing alone does not reach. These conventional oral cleansers achieve the cleansing intended, but the effectiveness is short lived. Bacterial reproduction accrue in one or two hours later, or even minutes later. Making the cleansing of the oral cavity through conventional methods ineffective.

The oral cleansing system 100 of the present invention has addressed and resolved this problem by using a unique liquid oral cleansing solution 14. By flossing and then brushing with this liquid solution 14 (in a conventional method), the solution 14 behaves much like normal toothpaste, gel or powders through the disruption of bacteria by action of the bristle in combination with potassium(chloro)flouride and benzoic acids, causing immediate cleansing of bacteria. But it has a second stage of controlling the reproduction of degenerative microorganisms well after the initial cleansing through brushing. This is performed by coating of the oral cavity with millions of “bait like” structures called lipido-lysogenases. These unique structures are very attractive to the oral micro-organisms and are ingested by the micro bacteria. Upon ingestion, the microorganisms will lyse or rupture, thus controlling the reproduction of oral bacteria. Since these unique “bait like” structures bond to the oral cavity surfaces, the rinsing performed after the initial brushing will not wash them away, leaving millions in the mouth to continue to kill off bacteria, keeping the oral cavity cleansed for a significantly longer period of time. This, in combination with the inventive special delivering device/toothbrush/dental floss dispenser, makes the oral cleansing system 100 very effective.

The following is an introduction and explanation of new chemistry as it pertains to the creation of the oral hygiene cleansing solution 100 of the present invention.

Conventional toothpastes or gels contain chemistry that is detrimental to the fats and proteins commonly found in the oral cavity. Oral hygiene must therefore be designed to promote the degeneration of any microorganisms that metabolize, feeds upon residual protein or fats and then reproduces as a result. Oral hygiene must in conclusion prevent the regeneration of any mixed flora (specifically micro bacteria) that by normal respiration and reproduction can cause the tooth decay and necrosis of the surrounding tissue matrix. It is considered is essential to reconsider conventional chemistry and to consider prior methodology as ineffective. By the present invention, a new methodology as well as new chemistry has been applied in an effort to redefine oral hygiene as well as decay prevention of both teeth and gums.

This solution is designed to eliminate bacteria in the oral cavity by eliciting a two stage method.

The first stage is a simple one—by flossing and brushing (in a conventional method), the oral cleansing solution 14 behaves much like a normal toothpaste or gel. The disruption of bacteria is accomplished by action of the bristle in combination with the potassium(chloro)fluoride and benzoic acids acting to cause the immediate cleansing of immediate micro-organisms on most of the oral surfaces. In many instances, most of the more “aggressive” micro-organisms manage to survive this process only to reproduce minutes and hours later. The present invention has provided a solution to the degenerative reproduction of oral bacteria by introducing a second stage of preventative oral hygiene, as follows.

The second stage of this inventive cleansing method is quite effective and does not require any further flossing or brushing. In fact, the solution to the degenerative regeneration of micro-organisms (bacteria) is accomplished by the organisms themselves The inventive method involves the use of millions of micro “bait like” structures called lipido-lysogenases. These unique structures are very attractive to oral micro-organisms and are ingested quite well by micro-bacteria. Upon ingestion of these micro morsels, the microorganisms will lyse or rupture and do no further damage to the treated oral surfaces. These structures will adhere to the oral surfaces, and the rinsing performed after the initial brushing will not wash them away, thus leaving millions of such structures in the mouth to destroy bacteria.

Actived Lipido-Lysogenases: Ingestion by Micro-bacteria in the Oral Cavity

This is a new oral hygiene method, namely a product designed to simplify the fight against the process of decay. This process employs a unique combination of Potassium Flouride, Sorbitol, Sodium Lauryl Sulfate, Benzoate, Calcium Carbonate, Sodium Chloride in a Glycerin suspension (flavor & color also added). No silicate or grit of any kind will threaten the integrity of the enamel. The specialized method of dispensing is paramount.

The following chemistry applies: the second stage oral cleansing will be accomplished by applied lipido-lysegenic lipases that will act as a decay preventative by lysenogenic action-with micro-organisms of unspecified nature. Mixed flora in the oral cavity can become amplified by the presence of short chain sugars and retacent proteins. The present invention intends to eliminate the capacity for regeneration of any staphlo-dipplo-strepto forms of microbacteria by creating a lysenogenic barrier. This is a form of protection in that the reproducing micro-organisms will have only residual protein within the oral cavity with which to sustain any reproductive metabolism.

Upon ingestion the micro-bacteria becomes lysogenated by the activated fatty acids. The result is that any bacteria ingesting the Lipido-Lysogenaces will be destroyed. The other micro-organisms such as Candida Albicans or Trichomonas will be destroyed by PH changes imposed due to the presence of Calcium Carbonate.

The inventive method clearly shows that any reduction in micro-organic concentration will be the result of a controlled ingestion of Lipido-Lysogenased Fatty Acids as well as a desired change in PH.

The two liquids that form the emulsion of the oral cleanser are:

1. A combination of potassium(chloro)flouride, Sorbitol, Sodium Lauryl Sulfate, Benzoate, Calcium Carbonate, Sodium Chloride and flavor and coloring in a glycerin suspension.

2. Lipido-lysogenased fatty acids in a carboxylic acid suspension.

Characteristics of the lipids used for the lipido-lysogenic lipases “bacterio-bait” are:

a. Usually a monocarboxylic acid —R—CO₂H

b. The “R” group is usually an unbranched chain.

c. The “C” atom is almost always even (or, the “C” atoms are almost always even).

d. The “R” group may be saturated or may be one or more double bonds ═ which are usually CIS.

The characteristic of the carboxylic acid used as the suspension for the “bacterio-bait” is (saturated) carboxylic acids of 10-18 carbon atoms.

Natural fats are referred to as Triacylglycerols. This group of lipids are the most abundant and the cheapest. They are often referred to as “Neutral fats” or “Triglycerides”. Examples of these include woolfat, lard, tallow, butter fat, cottonseed, corn, peanut oils, and soybean.

Natural characteristics of long fatty acids are unique in their structure and stability in situ. The reason for using fatty acids as “bacteria bait” is because of this stability. This is demonstrated as follows.

Lipido Stability Characteristics are as follows:

1. Usually a monocarboxylic acid —R—CO₂H.

2. The “R” Group is usually an unbranched chain.

3. The “C” Atom is almost always even.

4. The “R” Group may be saturated, or may be one or more double bonds.

The physical process of conversion from unique liquid oral hygiene solution to foam is as follows.

The canister containing the liquids as described previously will contain the agent of conversion by agitation. This agitation will occur as a result of the physical agitation of two liquids whose specific gravities differ by 0.1 point or more. These liquids will remain separate in the form of an emulsion. As the emulsion is forced through the physical agitator, the emerging fluid undergoes a phase change where the resulting fluid is of a solid/liquid consistency referred to hereafter as “foam”.

The term “foam” refers to any mass of bubbles formed on the surface of a liquid usually in a lightweight cellular form. The cells of air are (in these specific cases) created as a result of CO₂ liberation upon agitation of the emulsion within the canister 15.

The canister 15 itself must be pressurized under positive pressure whereby the fluid is forced outward toward the exit valve of the canister 15. Prior to expulsion, the liquids of distinct specific gravity will combine in the process of physical agitation at the agent of reaction known hereafter as the agitator.

The pressure acting as a force in a specific direction must originate within the canister and force the liquid therein toward the exit valve whereby it causes the agitation and subsequent release of CO₂ from within the emulsion by agitation at the “agitator”.

Emulsion to Emulsification:

1. Emulsion is when two or more fluids whose specific gravities vary by 0.1 pt. or more remain separate.

2. Emulsification is when an agent (which in the Oral Cleansing System is not chemical but physical) causes the two liquids to become intercombined on a micro-molecular scale to create a “phase” change emulsification.

The process described above is illustrated schematically in FIG. 16, which has been already described hereinabove.

Agent:

An agent can be either chemical or physical. A chemical is called “catalyst” or reagent when physical is the result of pressure, volume or temperature.

The canister housing and toothbrush of the present invention are designed as a single component. The toothbrush head and neck are integrally attached to a cylindrical housing. The housing has an inner chamber to encase the canister, which contains the “unique” liquid oral cleanser. Within this inner chamber there is another chamber section where the nozzle to channel “disk” fits precisely where it is to go. This section has an offset arc that is within the overall circumference of the canisters' chamber. This creates an irregular shaped chamber which forms two points that are used as a guide so that the “disk” fits aligned. This irregular shaped chamber leads to a smaller chamber that's allocated to a section of the disk. This smaller chamber leads to a cylindrical conduit. The points mentioned as guides assures that the section of the “disk” aligns with its' allocated chamber, making the assembly of the delivering device non-complicated and non-expensive. The “disk” is placed flush against a blind wall within the irregular shaped chamber, giving it a solid surface to hold the pressure created by the button being pushed which in turn pushes the canister forward onto its' nozzle that pushes against the inner section of the “disk”. Within the toothbrush neck and head there is a cylindrical conduit that leads to the bristled surface outlet. The size of the conduit should be kept the same as to the inner section of the “disk”. By keeping the size uniform, it controls the expansion of the converted foam solution, while maintaining the pressure toward the outlet (s).

The canister push button is a two piece component which consists of a button housing 11 and a button 10. The button housing 11 does not restrict the movement of the actual button except for preventing the button from sliding out through one of the openings. Its purpose is to be able to enclose the canister in the housing chamber of the delivering device, while housing a piece of plastic button that can be pushed against the bottom of the canister which will cause the discharge of the solution. Also, it is designed to prevent accidental discharge by concealing the actual button, thus not leaving it totally exposed. To dispense the cleansing solution, the user will have to put his/her finger over or in the opening provided and then push the button. The button housing sits on the open end of the cylindrical canister housing by means of a rabbet joint, which may be permanently sealed by an adhering or adhesive process when the system is made as a disposable one or threaded when made refillable.

The canister nozzle to channel “disc” is a very important piece. It permits the nozzle of the canister to connect to the cylindrical conduit which leads through the toothbrush neck and head. The “disc” is designed with a section where the nozzle of the canister is inserted and then restricted from entering the smaller channel inside the “disc”. The section of the “disc” that connects to the cylindrical conduit in the toothbrush neck is designed to fit snugly into the smaller chamber allocated within the irregular shaped chamber section that houses the “disc”. By using this method of connection, it permits the nozzle of the canister to remain centered, while still allowing the flexibility to design the overall integrity of the delivering device. Thus, the present invention provides a simple and cost effective overall structure.

The cylindrical sheath used as a dental floss dispenser is designed to function in two ways. One is as a toothbrush head and neck cover, and the second being to serve as the housing for the dental floss spool. The cylindrical sheath has two open-ended compartments; the first compartment is for receiving the bristled head and toothbrush neck. The inner wall of this open-end compartment has a has a section that is rabbeted to a channel-like ring, creating a channel lock which is used to temporarily secure the cylindrical sheath on the oral cleansing delivering device when it is not in use. When placed on the delivery device, it secures a ridged lock ring. The second compartment is used to accommodate a spool of dental floss and the dental floss dispensing cover. The inner wall of this open-end compartment has a rabbet section used as a “channel lock” used for locking in place the dental floss dispensing cover by its rabbet section.

The dental floss dispensing cover is designed to enclose the floss spool in its compartment and to provide the means to dispense floss. The cover has a shaft where the spool of floss is placed. It has a floss dispensing hole and a slot for the flosscutter, they are positioned distal to each other for the purpose of leaving a space in between that is concave circular. This will facilitate grasping the floss when it is extended across, cut and pinched by the floss cutter. The concave section is in the center of the cover. This design doesn't allow the floss to accidentally go back in the enclosed compartment, at the same time leaving a sufficient length of floss for grasping for future dispensing. On the outside circumference of the cover there is a rabbet section that fits inside the rabbet section of the floss compartment.

It is noted that in between the bristles there can be a hole(s) or slit(s) where the foamed solution exits the bristled surface.

As described above, a physical agitating agent is used to cause a “phase” change of the liquid oral cleansing solution contained in the canister. Although it is described to be placed within the canister, its placement in other sections within the system is also contemplated as being within the scope of the present invention. Placements being advantageous to the functionality of the system are: inside the canister right before entering the nozzle, within the nozzle, and/or right in front of the nozzle. Other placements could possible be made so long as they are not unduly disadvantageous to the integrity of the system.

The locking method described to secure the dental floss dispenser/floss compartment cover may be optionally with the fastener pegs shown when the cylindrical sheath is made from a less flexible plastic. The rabbet joint method is advantageous when a more flexible plastic is used for the sheath.

The toothbrush head is shown with a slight upward slant. It can be also designed to be straight. The design of the slight slant is for the purpose of structure style.

The invention being thus described, it will be evident that the same may be varied in many ways. Such variations are not to be regarded as a departure from the spirit and scope of the invention and all such modifications are intended to be included within the scope of the claims.

What is claimed is:

1. An oral cleansing system, comprising:
a housing containing a liquid oral cleansing solution;
a toothbrush carried by said housing; and
a sheath releasably connected to said housing for covering said toothbrush.

2. An oral cleansing system as claimed in claim 1, wherein said sheath has two compartments, one compartment receiving said toothbrush for covering it, and the other compartment carrying a dental floss dispenser and compartment cover.

3. An oral cleansing system as claimed in claim 1, wherein said housing and said sheath carry an interlocking ring and groove structure for releasably securing said housing and said sheath.

4. An oral cleansing system as claimed in claim 1, further comprising a button and a button housing having two open ends, both of which are carried by said housing, said button being used to cause dispensing of said liquid oral cleansing solution.

5. An oral cleansing system as claimed in claim 1, further comprising a canister for containing said liquid oral cleansing solution, said canister being received within said housing.

6. An oral cleansing system as claimed in claim 1, wherein said liquid oral cleansing solution includes potassium fluoride, sorbitol, sodium lauryl sulfate, benzoate, calcium carbonate, and sodium chloride in a glycerin suspension.

7. An oral cleansing system as claimed in claim 1, wherein said liquid oral cleansing solution includes applied lipido-lysegenic lipases.

8. An oral cleansing system as claimed in claim 1, wherein said liquid oral cleansing solution is composed of two liquids that, when dispensed, form an emulsion for use as an oral cleanser.

9. An oral cleansing system as claimed in claim 8, wherein a first of said two liquids includes potassium(chloro)fluoride.

10. An oral cleansing system as claimed in claim 9, wherein a second one of said two liquids includes lipido-lysogenased fatty acids in a carboxylic acid suspension.

11. An oral cleansing system as claimed in claim 1, further comprising an agitating means for causing foaming of said liquid oral cleansing solution when said liquid oral cleansing solution is dispensed.

12. An oral cleansing system, comprising:
a housing;
a canister received in said housing, said canister containing a liquid oral cleansing solution;
a toothbrush carried by said housing, said toothbrush having a passage therein for conveying liquid oral cleansing solution;
a sheath releasably connected to said housing for covering said toothbrush;
a roll of dental floss carried within said sheath; and
a disc connecting said canister to said passage in said toothbrush.

13. An oral cleanser that employs lipido-lysogenases to inhibit the reproduction of degenerative bacteria in the oral cavity.
